(19) United States
(12) Patent Application Publication
(10) Pub. No.: US 2014/0231391 A1
(43) Pub. Date: Aug. 21, 2014

(54) SWITCHGEAR OPERATING MECHANISM AND SWITCHGEAR

(71) Applicant: KABUSHIKI KAISHA TOSHIBA, Minato-ku (JP)

(72) Inventors: Tadashi Iwasawa, Kanagawa-ku (JP); Yoshikata Kobayashi, Hachioji-shi (JP); Satoshi Marushima, Takatsu-ku (JP); Masaharu Shimizu, Totsuka-ku (JP); Masahiro Nagao, Totsuka-ku (JP); Tatsuya Watanabe, Musashimurayama-shi (JP); Hirokazu Takagi, Izumi-ku (JP); Yoshiaki Ohda, Totsuka-ku (JP)

(73) Assignee: KABUSHIKI KAISHA TOSHIBA, Minato-ku (JP)

(21) Appl. No.: 14/345,850

(22) PCT Filed: Sep. 19, 2012
(86) PCT No.: PCT/JP2012/073925

§ 371 Date: Mar. 19, 2014

(30) Foreign Application Priority Data
Sep. 20, 2011 (JP) 2011-204024

(51) Int. Cl. H01H 33/50

(52) U.S. Cl. CPC H01H 33/50
USPC 218/78

(57) ABSTRACT

A switchgear and an operating mechanism thereof which stably maintain a spring force by a shutoff spring, and reduce an opening time. The operating mechanism includes a main lever that rotates upon receiving the spring force by a shutoff spring released in a transition to a shutoff condition to move a movable contact apart from an opposing contact, and the main lever is linked with a sub lever fixed to a sub shaft rotatable around its shaft. The sub shaft is fixed with a latch lever with a roller attached to the tip thereof. The latch lever is prevented from rotating by a latch present on a movement trajectory of the roller. A weight is pushed against the latch in a separable manner, and the weight is pushed by an actuator to allow the latch to rotate, thereby being retracted from the movement trajectory of the roller.

### TECHNICAL FIELD

The present disclosure relates to a power switchgear installed in a transformer station or a switching station, and an operating mechanism thereof.

### BACKGROUND ART

Switchgears with a current shutoff function are called as a load switch, a disconnecting switch, a shutoff switch, etc., in accordance with the application purpose and the necessary function, but are in common that junctions are relatively separated/connected to change a state between a current shutoff and a current loading. Example operating mechanisms for separating/connecting the junctions are one that utilizes hydraulic operating force which can obtain large output, and one which utilizes spring operating force of middle and low outputs.

Operating mechanisms utilizing hydraulic operating force are generally referred to as hydraulic operating mechanisms, and operating mechanisms utilizing spring operating force are generally referred to as spring operating mechanisms. Recently, downsizing of an arc-extinguishing chamber provided in a gas shutoff switch that is a kind of switchgears is advancing, and thus a spring operating mechanism that can shut off an accident current, etc., with a little operating force is adopted in many case examples.

In this case, in the case of a gas shutoff switch that is capable of shutting off an ultra-high voltage, a fast-speed operating performance called a two-cycle shutoff is necessary. The two-cycle shutoff is to shutoff a current within a time by what corresponds to the AC two cycles. According to switchgears employing the conventional spring operating mechanism, however, from the standpoint of the responsiveness of the latch mechanism that holds the spring force of a shutoff spring, the operating performance of a three-cycle shutoff or so is typical, and thus accomplishment of the two-cycle shutoff is not easy.

Patent Documents 1 to 3 disclose a first example of a conventional switchgear employing such a spring operating mechanism. According to the switchgears disclosed in Patent Documents 1 to 3, the force by the shutoff spring is held by a latch mechanism including a latch, an o-prop (open latch lever), and a catch, through an output lever. According to this first conventional example, when a current is caused to flow through a solenoid actuator, a plunger actuates the catch. In this case, the engagement between the catch and the prop is canceled, and the engagement between the output lever and the latch is canceled. Hence, the output lever is rotated to release the shutoff spring, thereby performing a shutoff operation.

In addition, Patent Document 4 discloses a second example of a conventional switchgear employing such a spring operating mechanism. According to the switchgear disclosed in Patent Document 4, a structure is employed in which a release lever and a holding lever are disposed to hold the force by a shutoff spring, and the hold lever is actuated by force of an acceleration spring, not by force of the shutoff spring at the time of a shutoff operation, to release the force by the shutoff spring.

### CITATION LIST

Patent Document 1: JP H11-213824 A
Patent Document 2: JP 2000-40445 A
Patent Document 3: JP 2007-294363 A
Patent Document 4: Japan Patent No. 3497866

### SUMMARY

### Technical Problem

According to the first conventional example, a releasing operation of the shutoff spring includes three operations: an operation of the catch upon excitation of the solenoid; an operation of the o-prop; and a separating operation of junctions including the shutoff spring. The relationship among those operations will be illustrated in FIG. 18. The horizontal axis represents a time axis, while the vertical axis represents the stroke of each part. A curved line at the bottom represents a waveform of a trip current, an operating curve of the catch is indicated thereabove, and the stroke of the o-prop and the shutoff spring is further indicated thereabove. A conduction signal of a contact in an arc-extinguishing chamber in the gas shutoff switch is indicated at the top.

With reference to a time point at which a current is caused to flow through the solenoid, a time after the catch is actuated and until the o-prop starts operating is defined as T1. In addition, a time after the o-prop is actuated and until the shutoff spring starts operating is defined as T2. T3 represents a time after the shutoff spring is actuated and until it reaches an opening point. When an opening time is T0, according to the first conventional example, a relationship T0=T1+T2+T3 is satisfied.

In order to accomplish the two-cycle shutoff, it is necessary to set the opening time T0 to be equal to or smaller than a certain time. According to this first conventional example, however, after the current is caused to flow through the solenoid, not all components from the catch to the shutoff spring simultaneously start the operation, but the engagement with the o-prop is canceled after the catch is actuated to some level, and then the o-prop starts operating. After the o-prop is actuated to some level, the shutoff spring starts operating. Hence, according to this scheme that allows the multiple latch mechanisms to operate step by step, and to cancel the latching step by step, it is quite difficult to reduce the opening time T0.

For example, since the spring force of the shutoff spring is set based on the movable-part weight of the arc-extinguishing chamber, the opening speed, and the drive energy, there is a limit in the reduction of the time T3. An example scheme of reducing T2 is to reduce the weight of the o-prop and to increase the holding force to hold the shutoff spring. This enables a fast-speed operation. According to this scheme, however, when the holding force becomes large, it is necessary to increase the size of the o-prop in order to enhance the strength, and thus there is a limit in reduction of the weight. Hence, there is a limit in speed-up through an increase of the holding force. In addition, when the holding force increases, large force is applied to the engaged part between the o-prop and the catch, and thus the catch needs to be large in size, and a solenoid with a large electromagnetic force to operate such a catch becomes necessary.

Recently, in order to accomplish a high output by a solenoid, an excitation scheme utilizing a large capacitor is employed, but the current value that can flow through the solenoid has an upper limit value defined by standards, and thus there is a limit in accomplishing a high output. As explained above, according to conventional spring operating mechanisms, it is difficult to reduce the opening time.

Moreover, according to the second conventional example, a three-operation structure is employed in which, during a releasing procedure of the spring force of the shutoff spring, the release hook is actuated by an electrical magnet, the reset lever, the acceleration spring, and the holding lever operate substantially simultaneously, and the release lever and the shutoff spring operate simultaneously.

According to this conventional example, the force necessary for operating the holding lever is reduced by setting the direction of the holding force by the shutoff spring to be substantially the center of the rotation of the holding lever. In addition, the operation of the holding lever included in the second operation is speeded up by the acceleration spring to reduce the operating time. However, there is a physical difficulty in setting the operating time of the second operation to be zero second, and it is difficult to remarkably reduce the whole opening time because of the reason explained with the first conventional example.

In addition, according to the second conventional example, a technical problem is also pointed out that the stability is insufficient in holding the spring force by the shutoff spring. That is, first of all, since the direction of the applied force to the engaged portion between the release lever and the holding lever is set to be substantially the center of the rotation of the holding lever, there is a possibility that the release lever rotates in the shutoff operation direction due to forcible vibration application to the holding lever originating from external vibration, and unintentionally operates even in a condition in which no shutoff instruction is given. Second, it is unstable which direction around the rotation center of the holding lever the direction of the applied force is directed due to, for example, deformation of the engaged plane between a roller disposed in the release lever and the holding lever. Hence, when the applied force acts in the direction in which the holding lever performs a shutoff operation, there is a possibility that the release lever is disengaged even though no shutoff instruction is input. Third, the holding lever is actuated in the shutoff direction due to impulsive force when, in a loading operation, the roller pushes the holding lever and is engaged therewith again, and thus there is a high possibility that the shutoff operation is performed without a shutoff instruction.

As explained above, according to conventional spring operating mechanisms, it is difficult to sufficiently reduce the opening time and there is a possibility that the stability of holding the spring force by the shutoff spring is insufficient.

The present disclosure has been made to address the above-explained technical problems, and it is an objective of the present disclosure to provide a switchgear and an operating mechanism thereof which stably hold the spring force by the shutoff spring, and which reduce the opening time.

### Solution to Problem

To accomplish the above objective, an operating mechanism for a switchgear according to an aspect of the present disclosure causes a movable contact to contact an opposing contact or to separate therefrom to change a condition between a current shutoff condition and a loading condition, and the operating mechanism includes followings:

(1) a shutoff spring that is released when the condition transitions from the loading condition to the shutoff condition;

(2) a main lever that is supported pivotally has one end linked with the shutoff spring, has an other end linked with the movable contact, and rotates upon receiving spring force by the shutoff spring to move the movable contact apart from the opposing contact;

(3) a sub lever that has one end linked with the main lever, and is rotatable around an other end;

(4) a sub shaft that fixes the other end of the sub lever, and is rotatable around the shaft of the sub shaft;

(5) a latch lever that has one end fixed to the sub shaft, has an other end attached with a roller, and is rotatable around the one end together with an axial rotation of the sub shaft;

(6) a latch that is supported pivotally has an end present on a movement trajectory of the roller when in the loading condition to suppress a rotation of the latch lever;

(7) a weight lever that is provided with, at one end thereof, a weight which is separable from the end of the latch;

(8) a return spring that is attached to an other end of the weight lever, and pushes the weight against the end so as to position the end of the latch on the movement trajectory of the roller; and

(9) an actuator that pushes the weight to allow the latch to rotate, and to retract the latch from the movement trajectory of the roller.

In addition, a switchgear according to another aspect of the present disclosure changes a condition between a current shutoff condition and a loading condition, and the switchgear includes followings:

(1) an opposing contact and a movable contact that are capable of contacting or separating relative to each other;

(2) a shutoff spring that is released when the condition transitions from the loading condition to the shutoff condition;

(3) a main lever that is supported pivotally has one end linked with the shutoff spring, has an other end linked with the movable contact, and rotates upon releasing of the shutoff spring to move the movable contact apart from the opposing contact;

(4) a sub lever that has one end linked with the main lever, and is rotatable around an other end;

(5) a sub shaft that fixes the other end of the sub lever, and is rotatable around the shaft of the sub shaft;

(6) a latch lever that has one end fixed to the sub shaft, has an other end attached with a roller, and is rotatable around the one end together with an axial rotation of the sub shaft;

(7) a latch that is supported pivotally has an end present on a movement trajectory of the roller when in the loading condition to suppress a rotation of the latch lever;

(8) a weight lever that is provided with, at one end thereof, a weight which is separable from the end of the latch;

(9) a return spring that is attached to an other end of the weight lever, and pushes the weight against the end so as to position the end of the latch on the movement trajectory of the roller; and

(10) an actuator that pushes the weight to allow the latch to rotate, and to retract the latch from the movement trajectory of the roller.

### BRIEF DESCRIPTION OF DRAWINGS

FIG. 1 is a cross-sectional view illustrating an example switchgear according to a first embodiment;

FIG. 2 is an exploded structural diagram illustrating an example operating mechanism according to the first embodiment;

FIG. 3 is a detailed structural diagram illustrating a latch mechanism according to the first embodiment;

FIG. 4 is a structural diagram illustrating the latch mechanism right after a shutoff operation is started according to the first embodiment;

FIG. 5 is a structural diagram illustrating the latch mechanism during the shutoff operation according to the first embodiment;

FIG. 6 is an exploded structural view illustrating the whole operating mechanism during the shutoff operation according to the first embodiment;

FIG. 7 is a structural diagram illustrating a loading mechanism right after a loading is started according to the first embodiment;

FIG. 8 is a structural diagram illustrating the latch mechanism and a cam mechanism right after the loading is started according to the first embodiment;

FIG. 9 is a structural diagram illustrating the latch mechanism during the loading according to the first embodiment;

FIG. 10 is a structural diagram illustrating the latch mechanism right before the loading completes according to the first embodiment;

FIGS. 11A to 11C are each an exemplary diagram illustrating an equivalent mass model according to the first embodiment;

FIG. 12 is a structural diagram illustrating a latch mechanism according to a second embodiment;

FIGS. 13A to 13C are each a diagram illustrating a positional relationship among a latch lever, a latch, and a counterweight lever in a loading operation according to the second embodiment;

FIG. 14 is a perspective view illustrating a latch and a counterweight lever according to a third embodiment;

FIG. 15 is an enlarged structural diagram illustrating a tip of a latch according to a fourth embodiment;

FIG. 16 is a structural diagram illustrating a latch mechanism according to a fifth embodiment;

FIG. 17 is a structural diagram illustrating a latch mechanism according to another embodiment; and

FIG. 18 is a graph illustrating an operational relationship of respective mechanisms in a conventional switchgear.

### DESCRIPTION OF EMBODIMENTS

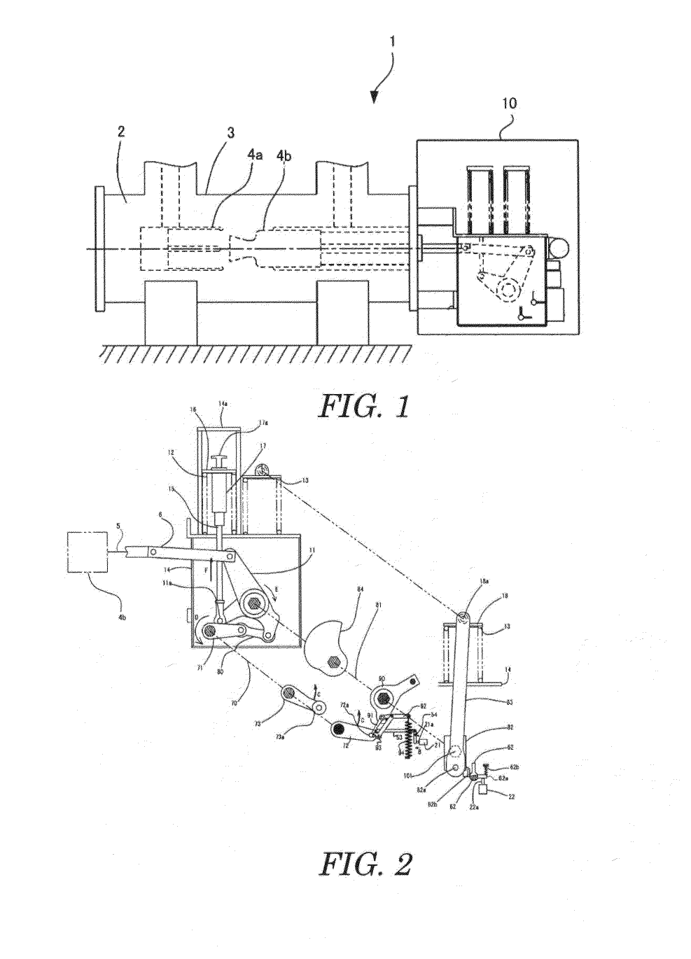

Embodiments of a switchgear and an operating mechanism thereof will be explained in detail with reference to FIGS. 1 to 17.

### First Embodiment

### Structure

FIG. 1 is a cross-sectional view illustrating an example switchgear according to an embodiment. The switchgear 1 is a gas shutoff switch that shuts off or loads a current by separating/contacting junctions in an arc-extinguishing gas 2. This switchgear 1 has an opposing contact 4a and a movable contact 4b disposed so as to face with each other in a sealed chamber 3 formed of metal or glass. The arc-distinguishing gas 2 is filled in the sealed chamber 3. The arc-distinguishing gas 2 is a gas with excellent arc-distinguishing performance and insulation performance, and is, for example, sulfur hexafluoride gas (SF₆ gas), but may be air, carbon dioxide, oxygen, nitrogen, or a mixed gas thereof which has a smaller global-warming-effect coefficient than that of SF₆ gas.

The opposing contact 4a and the movable contact 4b are each a conductor serving as an electrical junction. The opposing contact 4a and the movable contact 4b are capable of separating/contacting relative to each other. More specifically, the movable contact 4b is linked with an operating mechanism 10 provided in the sealed chamber 3. When the operating mechanism 10 pushes the movable contact 4b in the direction toward the opposing contact 4a, the movable contact 4b contacts the opposing contact 4a, and the switchgear 1 becomes a current loading condition. When the operating mechanism 10 moves the movable contact 4b away from the opposing contact 4a, the movable contact 4b is separated from the opposing contact 4a, and the switchgear 1 becomes a current shutoff condition.

FIG. 2 is an exploded structural diagram illustrating an example operating mechanism 10. In the operating mechanism 10, an operating rod 5 is a bar member fixed to the rear end of the movable contact 4b, and pushes/draws the movable contact 4b upon reception of drive force. The operating rod 5 is disposed in a coaxial manner with the movable contact 4b and the opposing contact 4a, and is slidable in the axial direction.

The operating rod 5 is linked with a main lever 11 through a linkage 6. The rear end of the operating rod 5 and the one end of the linkage 6, and, the respective other ends of the main lever 11 and the linkage 6 are linked with each other in a manner freely rotatable around the respective common pins.

The main lever 11 has three arms formed so as to extend radially, and has a rotation shaft in the radial center of the arm so as to be orthogonal to the extending direction of the arm. The main lever 11 has its position fixed at the rotation shaft, but is rotatable around the rotation shaft. The main lever 11 and the linkage 6 are linked at the tip of a first arm among the arms of the main lever.

A second arm that is another arm of the main lever 11 is located in a counterclockwise direction from the first arm when the direction in which the first arm becomes apart from the movable contact 4b is the clockwise direction. The second arm is linked with a shutoff drive source. The shutoff drive source includes a shutoff spring 12 that generates operating drive force to shut off a current, a damper 17 that attenuates vibration of the shutoff spring 12, a piston 17a that regulates the elongation range of the shutoff spring 12, and a linkage 15 that transmits force by the shutoff spring 12 to the main lever 11.

The shutoff spring 12 is a compression coil spring releases in the elongation direction. The shutoff spring 12 is disposed in a housing 14 retaining therein the main lever 11. The one end of the shutoff spring 12 is fixed to the housing 14, while the other end is free.

A damper 17 has a fluid filled therein, and has the one end fixed to the free end of the shutoff spring 12. A tabular spring receiver 16 is provided at the free end of the shutoff spring 12. The damper 17 has the one end fixed to the bottom of the spring receiver 16, and extends inside the shutoff spring 12 along the shaft thereof.

A piston 17a is provided at the upper face of the spring receiver 16. The piston 17a abuts the end face of the housing 14 retaining therein the shutoff spring 12, thereby restricting the elongation range of the shutoff spring 12.

The one end of the linkage 15 is fixed to the other end of the damper 17. The linkage 15 extends from the interior to the exterior along the shaft of the shutoff spring 12, and extends up to the second arm of the main lever 11. The other end of the linkage 15 and the tip of the second arm are linked with each other in a freely rotatable manner by a common pin 11a. The linkage 15 extends toward the first arm.

Next, a third arm that is the other arm of the main lever 11 is linked with a sub lever 71 through a linkage 80. The tip of the third arm and the one end of the linkage 80, and, the one end of the sub lever 71 and the other end of the linkage 80 are linked with each other in a manner freely rotatable by respective common pins. The other end of the sub lever 71 is fixed to a sub shaft 70 extended in a direction orthogonal to the elongation direction of this lever.

The sub shaft 70 is supported by an unillustrated bearing and is rotatable, but the disposed position thereof is fixed.

As explained above, the main lever 11 that converts the elongation operation of the shutoff spring 12 into a sliding operation of the movable contact 4b is engaged with the sub shaft 70 through the linkage 80 and the sub lever 71. Hence, the operating mechanism 10 changes the condition of the sub shaft 70 from an unrotatable condition to a rotatable condition, thereby starting a shutoff operation. This operating mechanism 10 includes a latch mechanism that changes the condition of the sub shaft 70 between the unrotatable condition and the rotatable condition.

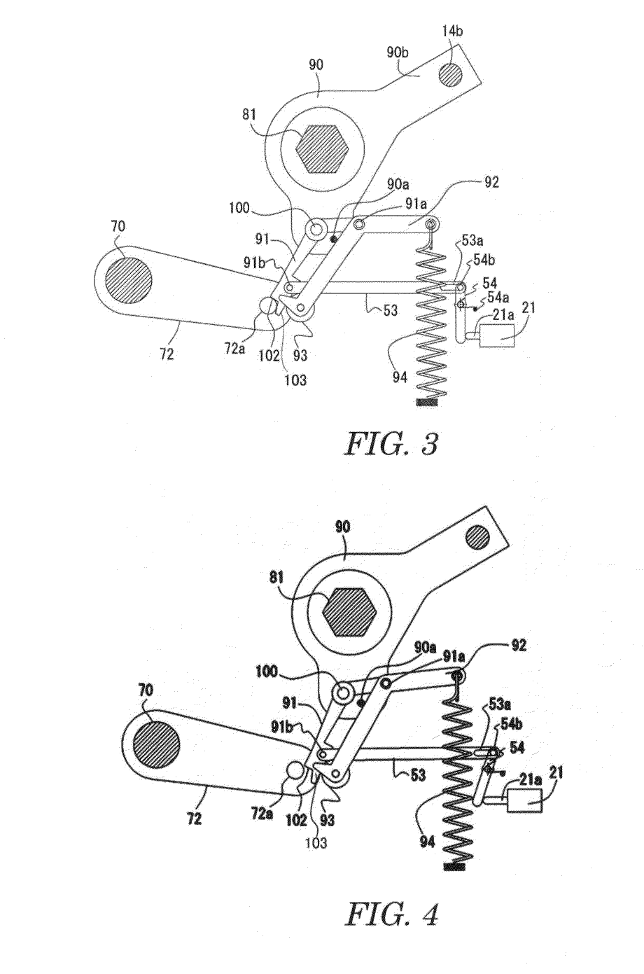

A detailed structure of the latch mechanism is illustrated in FIG. 3. As illustrated in FIG. 3, in addition to the sub lever 71, the sub shaft 70 is fixed with a latch lever 72. The latch lever 72 extends in a direction orthogonal to the sub shaft 70, and has the tip fitted with a cylindrical roller 72a in a freely rotatable manner which protrudes from the side face of this lever. When the latch lever 72 is latched, the sub shaft 70 becomes the unrotatable condition, and when the latching of the latch lever 72 is canceled, the sub shaft 70 becomes the rotatable condition.

Provided at the roller-72a side of the latch lever 72 is a latch 91 that latches the latch lever 72. The latch lever 72 is provided above a stopper lever 91e having a disposed position fixed so as to be unrotatable. The latch 91 has a rotation shaft 100 at the one end, and has a fixed disposed position by the rotation shaft 100, but is rotatable around the rotation shaft 100. The latch 91 extends so as to be present at a point (hereinafter, referred to as a latch point) on the movement trajectory of the roller 72a of the latch lever 72.

The latch 91 has a plane 102 provided at the end thereof and extending to the latch point. The plane 102 is present in a direction in which the roller 72a of the latch lever 72 moves at the time of the shutoff operation, and is substantially orthogonal to the movement trajectory of the roller 72a. When the latch 91 is present at the latch point, the plane 102 abuts the roller 72a of the latch lever 72, and prevents the latch lever 72 from rolling.

The plane 102 is formed so as to have the rotation shaft 100 of the latch 91 on a virtual normal line when the virtual normal line is considered as being orthogonal to the flat face of that plane. Hence, the rotational force by the latch lever 72 is converted into vectors directed toward the rotation shaft 100 from the plane 102, and hardly affects the rotation direction of the latch 91.

Still further, the latch 91 has a roller receiver 103 provided adjacent to the plane 102. The roller receiver 103 extends in a manner substantially orthogonal with the plane 102. The roller receiver 103 catches the latch lever 72 when the latch lever 72 returns to the latch point at the time of the loading operation of the switchgear 1.

Such a latch 91 is swung by a solenoid actuator 21 through a linkage mechanism. The linkage mechanism includes a release linkage 53 linked with the latch 91, and a release lever 54 that is linked with the release linkage 53, and is swung by the solenoid actuator 21.

The one end of the release linkage 53 is linked with the latch 91 through a pin in a manner freely rotatable. The other end of the release linkage 53 is provided with an elongated hole 53a having a longer side along the elongation direction. The release lever 54 has a rotation shaft in the halfway thereof, and has the one end provided with a roller pin 54b. The release lever 54 has the roller pin 54b fitted in the elongated hole 53a of the release linkage 53 in a swingable manner, thereby being linked with the release linkage 53.

The release lever 54 abuts a plunger 21a of the solenoid actuator 21. The abutting position of the plunger 21a is the opposite side to the position where the roller pin 54b is disposed relative to the rotation shaft. In addition, the plunger 21a abuts the release lever 54 in such a manner as to rotate the release lever 54 in the clockwise direction when pushed out by the solenoid actuator 21. The term clockwise in the case of the release lever 54 means a direction in which the release linkage 53 moves in the opposite side to the latch 91.

Still further, this latch mechanism includes a counterweight unit 93 that assists the unrotatable condition by the latch 91. The counterweight unit 93 includes a counterweight lever 92, a counterweight 93, and a return spring 94.

The counterweight lever 92 is formed in a dogleg shape, and is provided with a rotation shaft 91a at the bent part thereof. A first arm extended from the rotation shaft 91a extends to the back of the roller receiver 103 provided at the tip of the latch 91. The cylindrical counterweight 93 is fixed to the tip of the first arm. A second arm extended from the rotation shaft 91a is fixed with the one end of the return spring 94. The return spring 94 pushes the counterweight 93 so as to contact the latch 91.

When the latch 91 and the counterweight lever 92 are considered as equivalent mass models, if the latch 91 and the counterweight lever 92 are defined as an equivalent mass m1 and an equivalent mass m2, respectively, those are designed so as to satisfy the following formula (1).

m2≧{e1/(1+e2+e1×e2)}×m1 (1)

e1 is a reflection coefficient between the latch 91 and the roller 72a of the latch lever 72, and e2 is a reflection coefficient between the latch 91 and the counterweight lever 92. When respective collisions are complete elastic collisions, since e1=e2=1, the following formula (2) is satisfied.

m2≧⅓×m1 (2)

The equivalent mass m1 of the latch 91 in the equivalent mass model is a value obtained by dividing the inertia moment around the rotation shaft 100 of the latch 91 by the square of the distance from the rotation shaft 100 to the contact point of the counterweight 93. Likewise, in the equivalent mass model, the counterweight lever 92 has the equivalent mass m2 that includes the counterweight lever 92 and the counterweight 93.

A stopper pin 90a engageable with the counterweight lever 92 is provided between the counterweight lever 92 and the latch 91. The stopper pin 90a restricts the rotatable range of the counterweight lever 92. Hence, the latch 91 that receives rotational force from the counterweight lever 92 has the swingable range restricted by the stopper pin 90a.

Returning now to FIG. 1, the operating mechanism 10 further includes a loading mechanism to cause the movable contact 4b to contact with the opposing contact 4a. In the loading mechanism, a loading spring 13 is provided on the upper face of the housing 14. The loading spring 13 is a compression coil spring. The loading spring 13 has the one end fixed to the upper face of the housing 14, and has the other end that is free. The loading spring 13 is biased in an elongation direction. The free end of the loading spring 13 is provided with a tabular spring receiver 18, and the spring receiver 18 is fixed with a pin 18a orthogonal to the elongation direction of the loading spring 13.

The pin 18a on the spring receiver 18 is linked with the one end of a bar-shape linkage 83 in a freely rotatable manner. The linkage 83 is linked with a loading lever 82. The loading lever 82 is linked with the other end of the linkage 83 in a freely rotatable manner. The loading lever 82 is fixed to a loading shaft 81. The loading shaft 81 has its disposed position fixed, but is freely rotatable around its shaft. The loading shaft 81 is supported by the rotation shaft of the main lever 11 in a manner rotatable relative to each other, and extends in parallel with the sub shaft 70.

With the switchgear 1 being in a shutoff condition, i.e., the movable contact 4b being separated from the opposing contact 4a, with the linkage 83 being a front side and the loading shaft 81 being a rear side, when the positional relationship between the linkage 83 and the loading shaft 81 is viewed, the shaft of the loading shaft 81 is located at the left relative to a center shaft 101 of the linkage 83. Hence, when the loading spring 13 is elongated, the loading shaft 81 rotates in the counterclockwise direction.

The loading shaft 81 is fixed with a cam 84. The cam 84 is formed in a sector shape, and has a cam face at the arc portion. The cam face has a distance from the shaft fixed to the loading shaft 81 continuously increasing. When a virtual line extending from the shaft of the cam 84 in the radial direction is considered, the distance between the shaft of the cam 84 and an intersection between the virtual line and the cam face becomes large as the loading shaft 81 rotates in the counterclockwise direction.

In addition, the sub shaft 70 is fixed with a cam lever 73 in a manner facing with the cam 84. The cam lever 73 has the one end fixed to the sub shaft 70, and has the other end provided with a roller 73a rolling over the cam face. Hence, when the loading shaft rotates in the counterclockwise direction, the cam lever 73 receives rotational force in the clockwise rotation direction through the cam face.

According to such a loading mechanism, the loading lever 82 is held by the latch mechanism. In this latch mechanism, the loading lever 82 is provided with a pawl 82b. The pawl 82b is engaged with a semi-cylindrical member 62 in a freely detachable manner. The semi-cylindrical member 62 is movable in a direction orthogonal to the flat face spreading in the axial direction, and when the pawl 82b and the long side of the flat face become the same height, the semi-cylindrical member abuts the pawl 82b, and when the pawl 82b and the circumferential surface become the same height, the semi-cylindrical member becomes apart from the pawl 82b.

Travelling force is applied to the semi-cylindrical member 62 by a solenoid actuator 22. More specifically, the semi-cylindrical member 62 is provided with a protrusion 62a in parallel with the flat face and in the orthogonal direction to the shaft. This protrusion 62a abuts a plunger 22a of the solenoid actuator 22 at the bottom of the semi-cylindrical member 62 located at the circumferential-surface side. Hence, when the plunger 22a is pushed, the semi-cylindrical member 62 moves upwardly, and the engagement between the pawl 82b and the semi-cylindrical member 62 is canceled, and thus the loading lever 82 becomes rotatable.

In the protrusion 62a, an opposite face to the face abutting the plunger 22a is fixed with a return spring 62b released in the elongation direction, and when the plunger 22a is retracted in the solenoid actuator 22, the semi-cylindrical member 62 is engaged with the pawl 82b, and thus the rotation of the loading lever 82 is suppressed.

According to such a switchgear 1, in the loading condition, the main lever 11 receives torque to separate the movable contact 4b from the opposing contact 4a by the shutoff spring 12. However, the rotation of the latch lever 72 is restricted by the latch 91, the sub shaft 70 fixed with the latch lever 72 is also unrotatable around its shaft, and the sub lever 71 fixed with the sub shaft 70 is also unrotatable. Hence, the main lever 11 linked with the sub lever 71 is unrotatable, and the current loading condition is maintained.

[First Operation: Shutoff Operation]

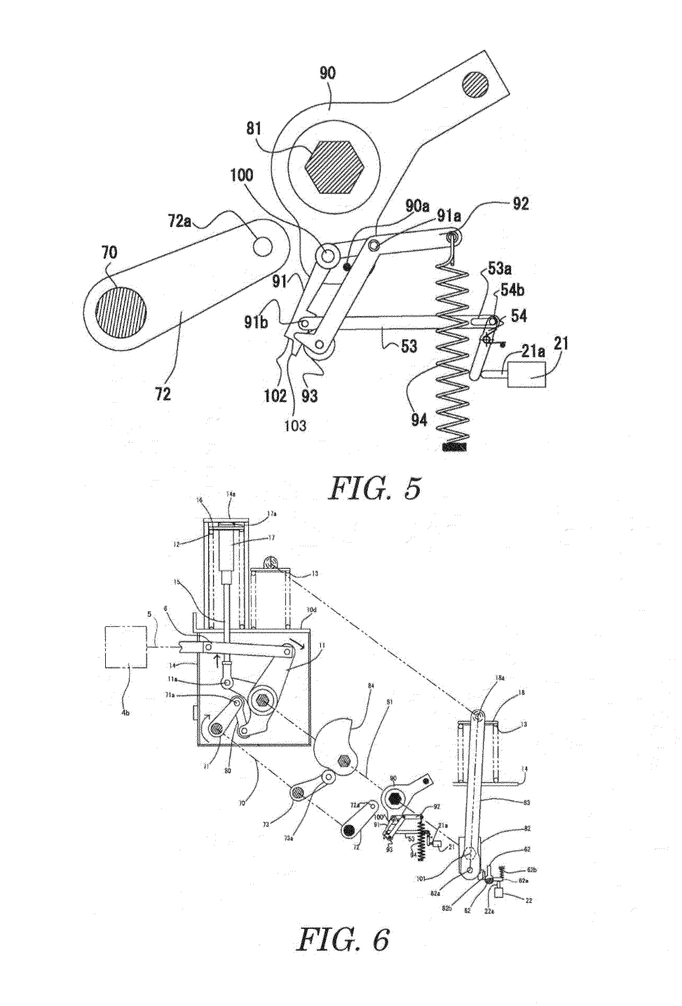

A shutoff operation by the switchgear 1 through the operating mechanism 10 will be explained with reference to FIGS. 4 to 6. FIG. 4 is a structural diagram illustrating the latch mechanism right after a shutoff operation starts. FIG. 5 is a structural diagram illustrating the latch mechanism during the shutoff operation, and FIG. 6 is an exploded structural diagram illustrating the whole operating mechanism 10 during the shutoff operation.

First, as illustrated in FIG. 4, when the solenoid is excited upon inputting of an external instruction, the solenoid actuator 21 pushes out the plunger 21a. When the plunger 21a is pushed out from the solenoid actuator 21, the release lever 54 abutting the plunger 21a rotates in the clockwise direction. When the release lever 54 rotates, the roller pin 54b provided at the tip of the release lever 54 slides the elongated hole 53a of the release linkage 53 toward the farthest end, and abuts the inner periphery of the elongated hole 53a.

When the plunger 21a is further pushed out, the release linkage 53 is pulled by the release lever 54 fallen down in the clockwise direction and moves to the opposite side to the latch 91. When the release linkage 53 moves, the latch 91 pushes the counterweight 93 at the back, and starts rotating in the counterclockwise direction around the rotation shaft.

While the latch 91 rotates by a certain angle, the plane 102 moves so as to push down the roller 72a of the latch lever 72, and thus the engaged relationship is maintained. When the latch 91 is further rotated, the plane 102 is released from the latch point, and becomes distant from the roller 72a. The separation of the plane 102 with the roller 72a cancels the holding of the latch lever 72.

When the holding of the latch lever 72 is canceled, as illustrated in FIG. 5, the latch lever 72 is permitted to rotate in the counterclockwise direction. That is, the sub shaft 70 becomes rotatable, the sub lever 71 becomes rotatable, and the main lever 11 becomes rotatable.

Hence, as illustrated in FIG. 6, the shutoff spring 12 is elongated, the linkage 15 lifts up the second arm of the main lever 11, and the main lever 11 rotates in the clockwise direction. When the main lever 11 rotates in the clockwise direction, the first arm falls down in the clockwise direction, and the linkage 6 linked with the first arm and the operating rod 5 move to the opposite side to the opposing contact 4a. Together with this movement of the linkage and the operating rod 5, the movable contact 4b is separated from the opposing contact 4a.

When the movable contact 4b is separated from the opposing contact 4a to some level, the piston 17a abuts the upper face of the housing 14, the damper 17 applies braking force, and thus the actuation of the shutoff spring 12 is terminated.

When the engagement between the latch 91 and the latch lever 72 is canceled, the latch lever 72 rotates, and the shutoff operation completes, the latch 91 has the counterweight 92 rotated to the same position as that of the loading condition by the return spring. Accordingly, the latch is pushed by the counterweight lever 92, and returns to the substantially same position as that of the loading condition, i.e., the plane 102 returns to the position near the latch point. The release linkage 53 and the release lever 54 also return to the substantially same positions as those of the loading condition when the plunger is retracted.

[Second Operation: Loading Operation]

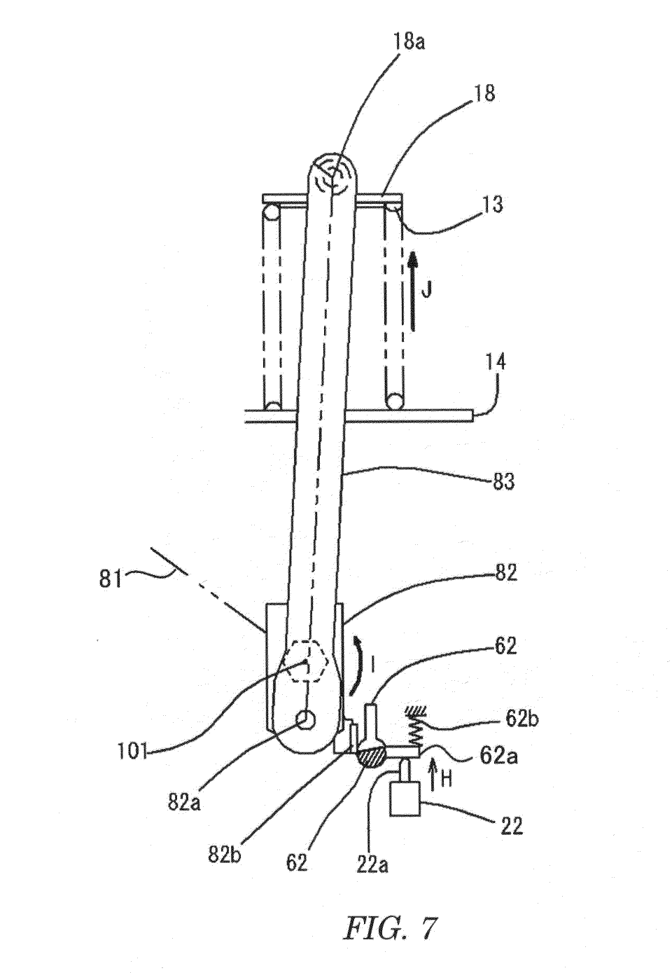

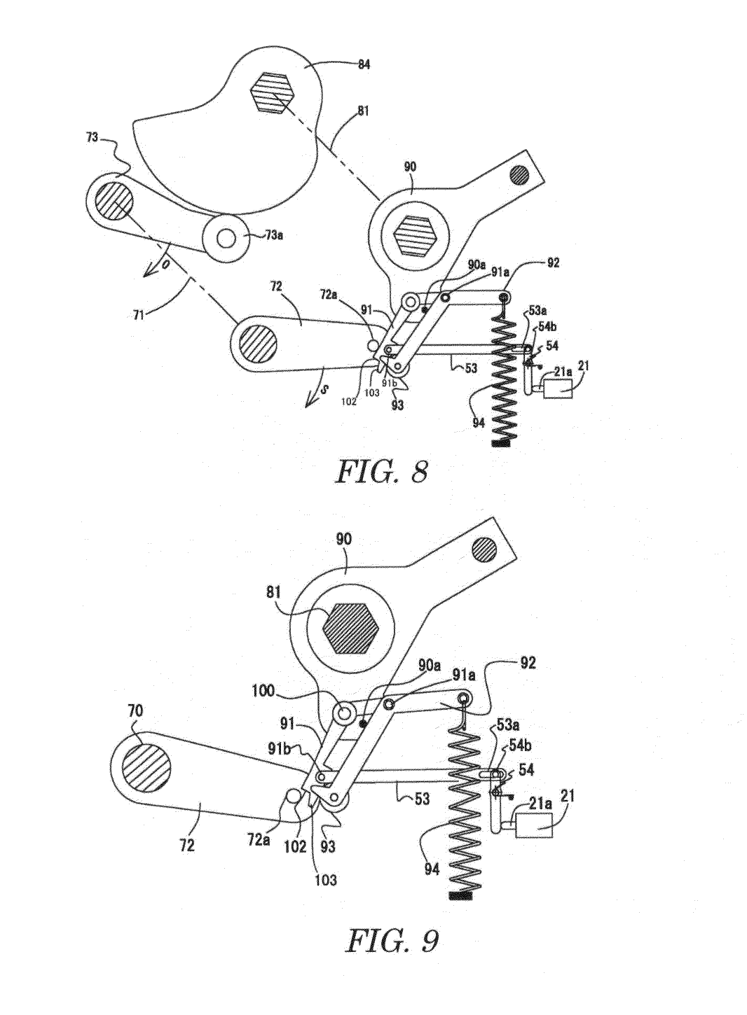

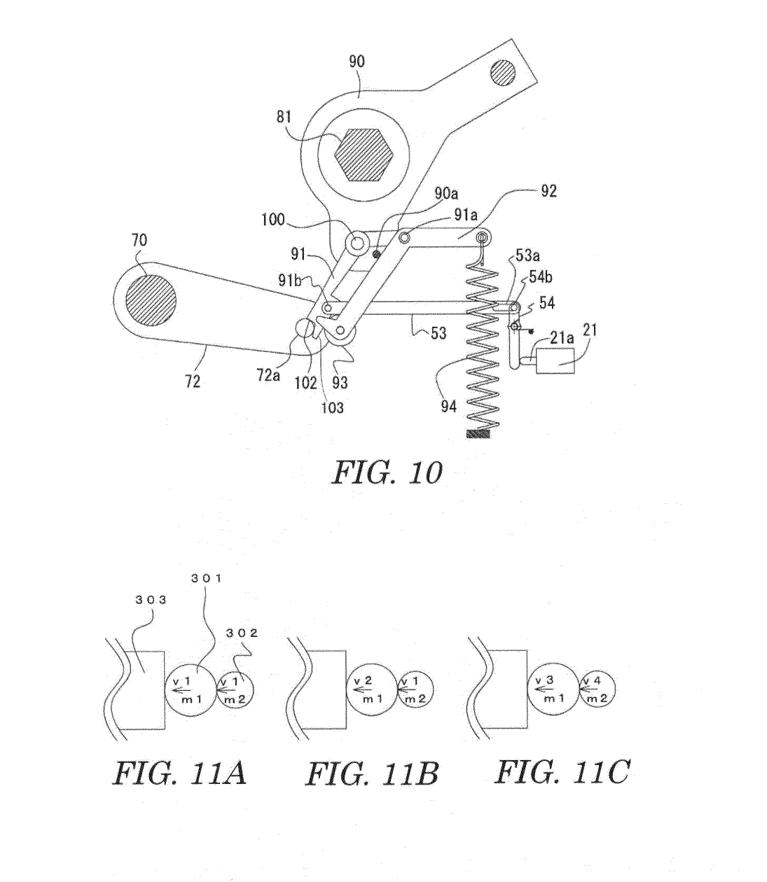

Next, an explanation will be given of the loading operation of the switchgear 1 by such an operating mechanism 10 with reference to FIGS. 7 to 11. FIG. 7 is a structural diagram illustrating the loading mechanism right after the loading operation starts, and FIG. 8 is a structural diagram illustrating the latch mechanism and the cam mechanism right after the loading operation starts. FIG. 9 is a structural diagram illustrating the latch mechanism during the loading operation, FIG. 10 is a structural diagram illustrating the latch mechanism right before the loading operation completes, and FIG. 11 is an exemplary diagram illustrating an equivalent mass model.

As illustrated in FIG. 7, when the solenoid actuator 22 pushes out the plunger 22a, the semi-cylindrical member 62 is lifted upwardly through the protrusion 62a. When the semi-cylindrical member 62 is lifted upwardly, the engagement between the pawl 82b of the loading lever 82 and the semi-cylindrical member 62 is canceled, and thus the loading lever 82 becomes rotatable.

When the loading lever 82 becomes rotatable, the loading spring 13 is elongated, and the linkage 83 is lifted up. When the linkage 83 is lifted, the loading lever 82 linked with the linkage 83 starts rotating in the counterclockwise direction around the loading shaft 81. Since the loading lever 82 is fixed to the loading shaft 81, the loading shaft 81 rotates in the counterclockwise direction around its shaft together with the rotation of the loading lever 82.

As illustrated in FIG. 8, when the loading shaft 81 rotates around its shaft in the counterclockwise direction, the cam 84 fixed to the loading shaft 81 also rotates in the counterclockwise direction, and the roller 73a of the cam lever 73 provided in a manner facing with the cam 84 slides over the cam face. When the cam 84 rotates counterclockwise, the position where the roller 73a of the cam lever 73 is abutting becomes continuously distant from the shaft of the cam 84. Accordingly, the cam lever 73 rotates in the clockwise direction so as to have the tip pushed downwardly.

When the cam lever 73 rotates in the clockwise direction, the sub shaft 70 fixed with the cam lever 73 also rotates in the clockwise direction around its shaft, and the sub lever 71 fixed to the sub shaft 70 also rotates in the clockwise direction. The sub lever 71 and the main lever 11 are linked with the single linkage 80, and thus when the sub lever 71 rotates in the clockwise direction, the main lever 11 rotates in the counterclockwise direction.

Hence, the first arm of the main lever 11 swings in the direction becoming close to the opposing contact 4a, and pushes the linkage and the operating rod 5 toward the opposing contact 4a. When the linkage and the operating rod 5 are pushed toward the opposing contact 4a, the movable contact 4b fixed to the tip of the operating rod 5 contacts the opposing contact 4a.

When the main lever 11 rotates through this loading operation, the second arm swings in the counterclockwise direction, and thus the linkage 15 is pulled downwardly. When the linkage 15 is pulled downwardly, the shutoff spring 12 is compressed and accumulates the compression force.

According to such a loading operation, as illustrated in FIG. 8, when the sub shaft 70 rotates in the clockwise direction, since the latch lever 72 is fixed to the sub shaft 70, the latch lever likewise rotates in the clockwise direction. That is, the roller 72a of the latch lever 72 moves toward the latch point.

During the clockwise rotation of the latch lever 72, first, the roller 72a of the latch lever 72 abuts the arm portion of the latch 91 returned by the return spring 94, and pushes the latch 91 in the counterclockwise direction. Next, when the roller 72a of the latch lever 72 reaches the latch point, as illustrated in FIG. 9, the roller is separated from the arm portion of the latch 91. At this time, the engagement of the latch 91 with the latch lever 72 is canceled, and thus the latch starts a return operation in the clockwise direction together with the counterweight lever 92.

In this case, as illustrated in FIG. 10, the latch 91 has the roller receiver 103 collided with the roller 72a of the latch lever 72, and this roller abuts the plane 102. It is set that, when the engagement between the arm of the latch 91 and the roller 72a of the latch lever 72 is canceled, the contact between the cam 84 and the cam lever 73 is also canceled, and the latch lever 72 attempts to rotate in the counterclockwise direction, but the collision with the roller receiver 103 of the latch 91 is sufficiently fast due to inertial force.

FIGS. 11A to 11C illustrate an equivalent mass model when the latch 91 and the latch lever 72 collide. As illustrated in FIGS. 11A to 11C, the latch lever 72 can be thought as a fixed wall 303. First, before a collision occurs, as illustrated in FIG. 11A, an equivalent mass model 301 of the latch 91 with an equivalent mass m1 and an equivalent mass model 302 of the counterweight lever 92 with an equivalent mass m2 move together, and thus both move toward the fixed wall at a velocity v1.

In this condition, as illustrated in FIG. 11B, when the equivalent mass model 301 of the latch 91 collides the fixed wall 303, the equivalent mass model 301 of the latch 91 rebounds and becomes a velocity v2, and, collides the equivalent mass model 302 of the counterweight lever 92 with the velocity of v1.

Next, as illustrated in FIG. 11C, when the latch 91 collides the counterweight lever 92, the respective equivalent mass models 301, 302 become a velocity v3 and a velocity v4.

Through the successive collision motions, when the rebound coefficient between the equivalent mass model 301 of the latch 91 and the fixed wall 303 is e1, the following formula (3) can be satisfied.

v2/v1=−e1 (3)

The following formula (4) is satisfied before and after the collision between the latch 91 and the counterweight lever 92 due to the momentum conservation law.

m1·v2+m2·v1=m1·v3+m2·v4 (4)

In addition, when the rebound coefficient between the latch 91 and the counterweight lever 92 is e2, the following formula (5) can be satisfied.

(v3−v4)/(v2−v1)=−e2 (5)

In this case, the following formula (6) is satisfied through the above formulae (3) to (5).

−e1·v1·m1+(v1+e2·v1+e1·e2·v1)·m2=v3·m1+v3·m2 (6)

As explained above, the latch 91 and the counterweight lever 92 are set so as to satisfy the following formula (1).

m2≧{e1/(1+e2+e1×e2)}×m1 (1)

Hence, v3≧0 through the above-explained formulae (1) and (6), and thus the latch 91 does not rotate in the counterclockwise direction due to a backlash when collided with the latch lever 72, and after the collision, the latch 91 and the latch lever 72 do not separate from each other.

When the above-explained formula (1) is not satisfied, since the velocity v3 after the collision with the counterweight lever 92 has a speed in a direction becoming apart from the latch lever 72 smaller than the rebound velocity v2 after the latch 91 collides the latch lever 72, and thus an effect of suppressing a separating motion of the latch 91 from the latch lever 72 due to a collision rebound can be obtained.

### Advantageous Effects

As explained above, according to the switchgear 1 of this embodiment, the latch mechanism that restricts the current shutoff operation has only one engagement relationship, more specifically, only the engagement relationship between the latch lever 72 and the latch 91. Hence, the total of two operations: the operation of releasing the engagement between the latch lever 72 and the latch 91; and the operation of the shutoff spring 12 are successively carried out, thereby performing the current shutoff operation. As explained above, the conventional shutoff operation through the shutoff spring 12 includes the total of three operations: the catch stroke; the o-prop stroke; and the stroke by the shutoff spring 12, but the shutoff operation can be completed through the two operations according to this embodiment. Accordingly, the opening time after the activation of the actuator is started can be reduced. More specifically, the same advantage as the case in which the time T2 of the o-prop stroke is eliminated can be accomplished.

The structure of employing the only one latch mechanism causes the counterweight 93 to hold the position of the latch 91 to be engaged with the latch lever 72, and to suppress a disengagement. Accordingly, this structure is effectively embodied.

In addition, when this counterweight lever 92 is provided on the back face of the latch 91 in a freely contactable/separable manner, it becomes possible to suppress a disengagement due to a collision between the latch 91 and the latch lever 72, and thus the operation reliability of the spring operating mechanism 10 improves.

Still further, the engagement face between the latch 91 and the latch lever 72 is formed as a plane, and the rotation shaft of the latch 91 is provided on a normal line orthogonal to the plane. Accordingly, the pressing force by the latch lever 72 is not likely to act in the rotation direction of the latch 91. Hence, the latch 91 can be downsized, and the force when the latch 91 is released from the latch lever 72 can be minimized, and thus the solenoid actuator can be made compact.

### Second Embodiment

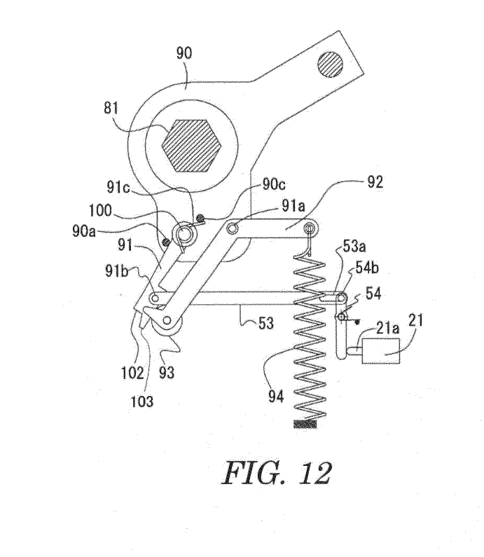

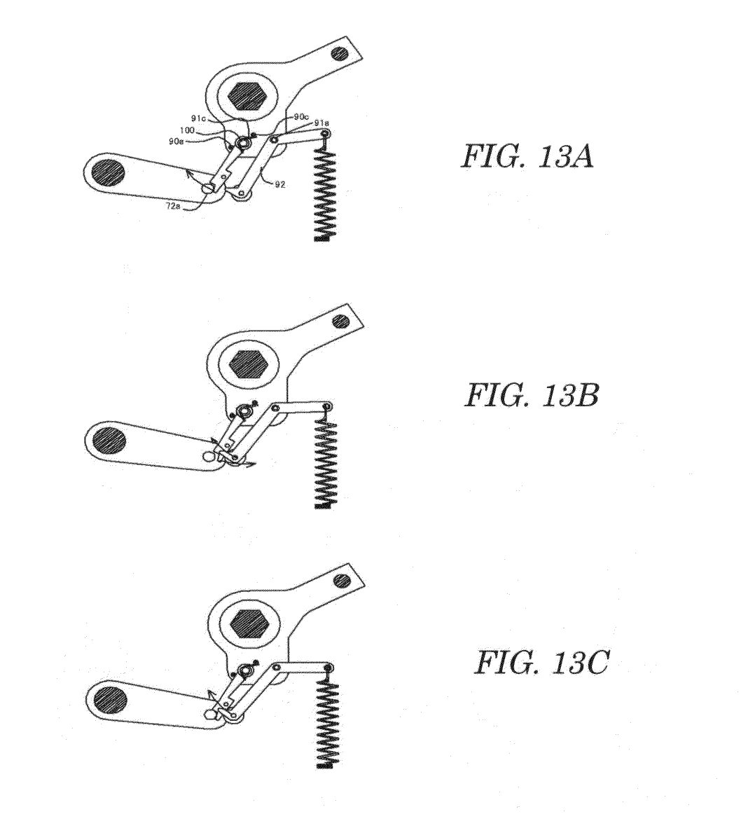

Next, an explanation will be given of the operating mechanism 10 of the switchgear 1 according to a second embodiment with reference to FIGS. 12 and 13. The same portion as that of the first embodiment will be denoted by the same reference numeral, and the detailed explanation thereof will be omitted.

FIG. 12 is a structural diagram illustrating a latch mechanism according to the second embodiment. As illustrated in FIG. 12, the latch 91 has a return spring 91c fitted to the rotation shaft. The return spring 91c is a twisted spring. The arm of the twisted spring spreads in a direction in which the latch 91 becomes apart from the latch lever 72, and abuts a stopper pin outwardly. Hence, the twisted spring always applies pushing force in such a way that the latch 91 is present on the movement trajectory of the roller of the latch lever 72. Therefore, the latch 91 is not likely to be separated from the latch lever 72.

In addition, provided near the other arm of the return spring 91c is the other stopper pin 90a which regulates the rotation range of the latch 91 in the clockwise direction.

FIGS. 13A to 13C are each a diagram illustrating a positional relationship between the latch lever 72, the latch 91 and the counterweight lever 92 at the time of a loading operation according to the second embodiment. As illustrated in FIG. 13A, when the latch lever 72 rotates so as to push the latch 91 in the loading operation, due to the presence of the return spring 91c, the latch 91 has the response speed slowed down, and the counterweight lever 92 first bounces due to the collision rebound, and is separated from the latch 91.

Next, as illustrated in FIG. 13B, when the latch 91 is bounced from the latch lever 72 due to the collision rebound, the counterweight lever 92 returns in the direction toward the latch 91, and abuts the latch 91. Hence, as illustrated in FIG. 13C, the bouncing of the latch 91 is reduced by the counterweight lever 92.

Therefore, according to the second embodiment, because of the presence of the return spring 91c, the rotation suppression effect by the latch 91 to the latch lever 72 is further improved, and the disengagement of the latch lever 72 from the latch 91 in the loading operation can be further effectively suppressed.

### Third Embodiment

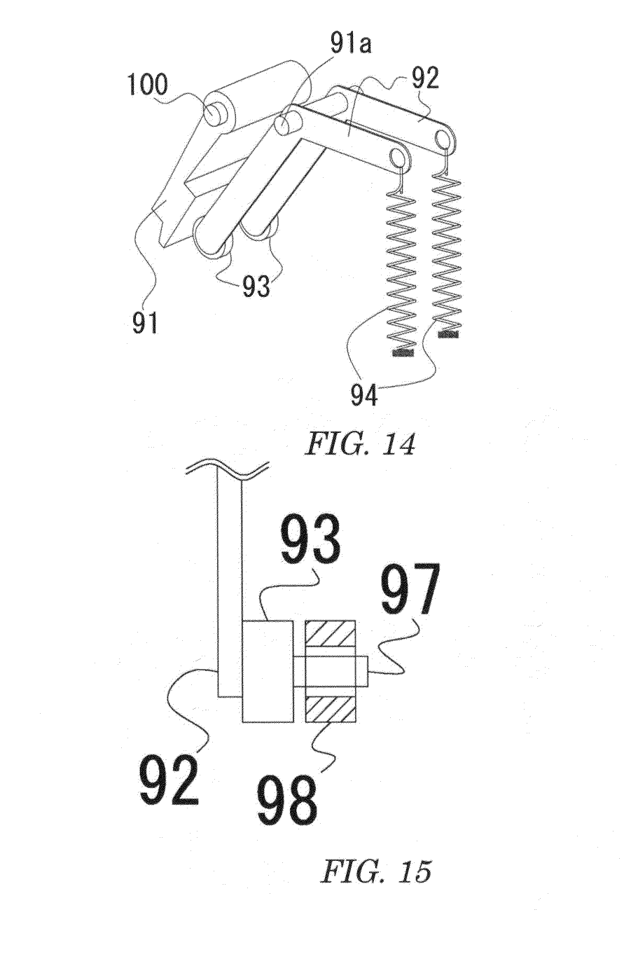

Next, an explanation will be given of the operating mechanism 10 of the switchgear 1 according to a third embodiment with reference to FIG. 14. The same portion as that of the first embodiment will be denoted by the same reference numeral, and the detailed explanation thereof will be omitted.

FIG. 14 is a perspective view illustrating the latch 91 and the counterweight lever 92 according to a third embodiment. As illustrated in FIG. 14, the operating mechanism 10 includes multiple counterweight levers 92. Each counterweight lever 92 has the counterweight 93 provided at the one end, and has the other end pushed by the return spring 94.

The multiple counterweight levers 92 have a difference in either one of or both of the weight of the counterweight 93 and the elastic coefficient of the return spring. Accordingly, in the loading operation, when the counterweight lever 92 is bounced from the latch 91, the return timing of each counterweight lever 92 to the latch 91 is shifted. Therefore, suppression force to the bouncing of the latch 91 from the latch lever 72 continuously works, and thus the disengagement between the latch lever 72 and the latch 91 is further effectively suppressed.

### Fourth Embodiment

Next, an explanation will be given of the operating mechanism 10 of the switchgear 1 according to a fourth embodiment with reference to FIG. 15. The same portion as that of the first embodiment will be denoted by the same reference numeral, and the detailed explanation thereof will be omitted.

FIG. 15 is an enlarged structural diagram illustrating the tip of the latch 91 according to the fourth embodiment. As illustrated in FIG. 15, provided at the tip of the counterweight lever 92 is a pin 97 in a protruding manner from the side face of the counterweight 93. The pin 97 extends in a manner orthogonal to the rotation direction of the latch 91.

The pin 97 is fitted with a ring 98. The ring 98 has the internal diameter larger than the diameter of the pin 97, and the ring 98 is movable in the radial direction of the pin 97. The ring 98 has substantially the same outer diameter as that of the counterweight 93.

In the operating mechanism 10 of the switchgear 1 according to the fourth embodiment, when the latch 91 collides the latch lever 72 and the reactive force thereof affects the counterweight lever 92 in the loading operation, the ring moves in the opposite direction to the bouncing direction of the counterweight lever 92 in accordance with inertial force, and hits the pin. Hence, the latch 91 is prevented from being separated from the latch lever 72 by the inertial force of the ring 98. Therefore, according to the fourth embodiment, the disengagement between the latch 91 and the latch lever 72 can be further suppressed.

### Fifth Embodiment

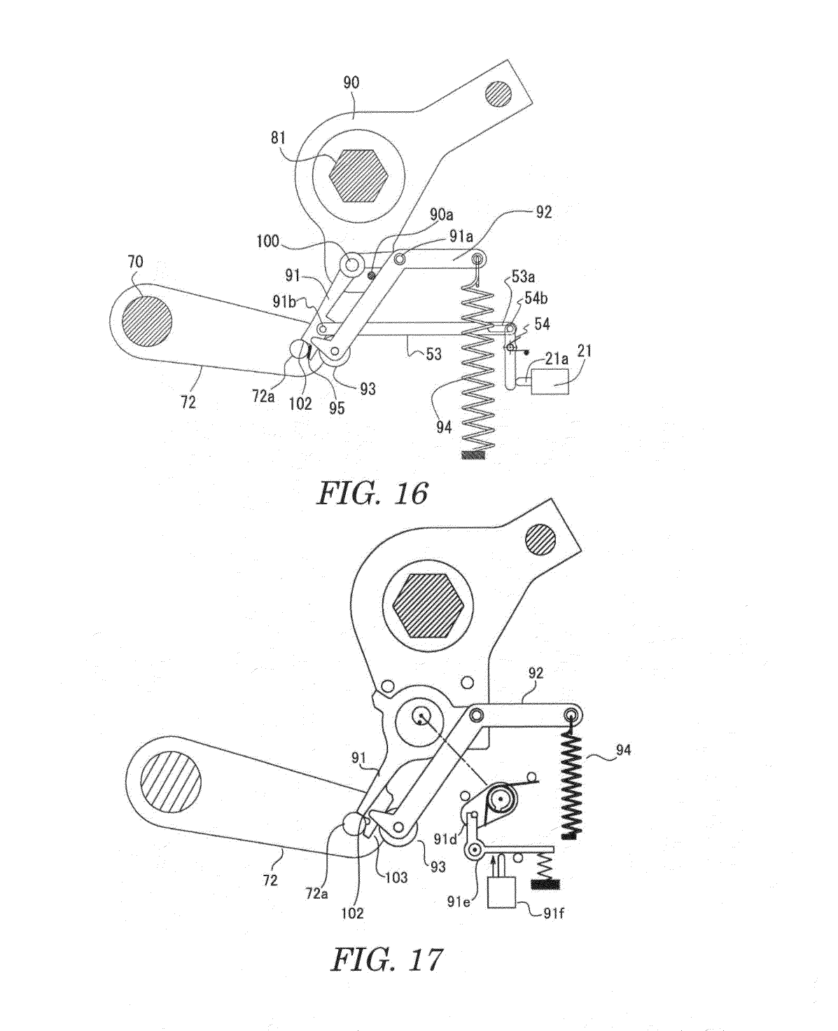

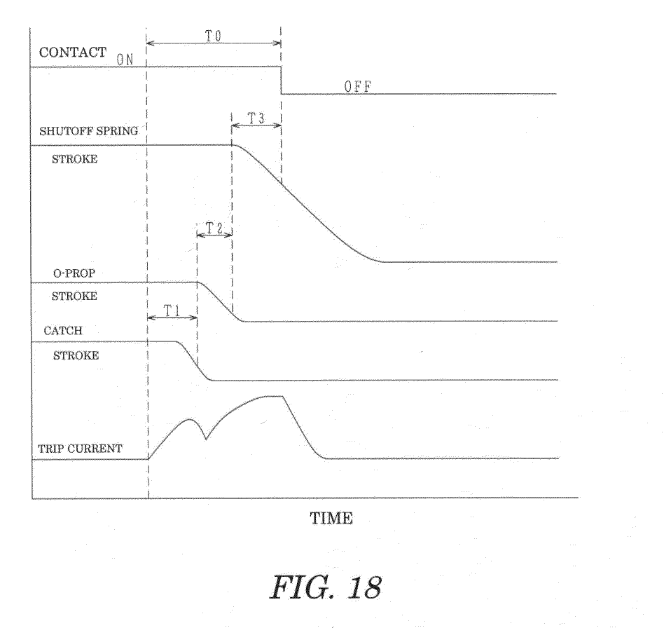

Next, an explanation will be given of the operating mechanism 10 of the switchgear 1 according to a fifth embodiment with reference to FIG. 16. The same portion as that of the first embodiment will be denoted by the same reference numeral, and the detailed explanation thereof will be omitted.

FIG. 16 is a structural diagram illustrating a latch mechanism according to the fifth embodiment. As illustrated in FIG. 16, a vibration absorbing member 95 is pasted on a surface of the roller receiver 103 of the latch 91 which collides the roller 72a. The vibration absorbing member 95 is formed of a material with a high vibration absorbing characteristic like a polymer material. Hence, when the roller 72a of the latch lever 72 collides the latch 91 in the loading operation, the shock thereof is absorbed by the vibration absorbing member 95, and thus the bouncing of the latch 91 is eased. Accordingly, the disengagement between the latch 91 and the latch lever 72 can be further effectively suppressed.

### Other Embodiments

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

For example, as illustrated in FIG. 17, according to a scheme in which a lever is fixed to the latch 91, the rotation of the latch 91 is held by pushing a stopper member 91e, and the pushing of the stopper member 91e is actuated or canceled by a solenoid actuator 91f, the counterweight lever 92 can be provided on the back of the latch 91.

In addition, the counterweight 93 may be formed in a circular cross-sectional shape or other shapes, and the similar advantages can be accomplished in both cases.

Still further, according to each of the above-explained embodiments, the compression coil spring is applied to the shutoff spring 12, the loading spring 13, and other return springs, but other elastic members, such as a helical torsion coil spring, a disc spring, a spiral spring, a plate spring, an air spring, or a tension spring, may be applicable.

Moreover, when the tip of the latch 91 is formed as a convex arcuate surface, and the center position of the arcuate surface is substantially aligned with a straight line interconnecting the center of the roller and the rotation center of the latch 91 in the loading condition, a time necessary for canceling the engagement between the latch 91 and the latch lever 72 can be reduced, and thus the opening time can be reduced.

In the second embodiment, the stopper pin 90c engaged with the return spring 91c fixed to the latch 91 and the stopper pin 90a that restricts the rotation of the latch 91 in the clockwise direction are respectively provided, but those stopper pins may be realized by a common single pin.

For example, the present disclosure is applicable to a switchgear 1 of a type which employs a so-called dual motion mechanism that actuates the opposing contact 4a to the opposite direction to the movable contact 4b to improve the relative opening speed.

### REFERENCE SIGNS LIST

1 Switchgear
2 Arc-distinguishing gas
3 Sealed chamber
4a Opposing contact
4b Movable contact
5 Operating rod
6 Linkage
10 Operating mechanism
11 Main lever
11a Pin
12 Shutoff spring
13 Loading spring
14 Housing
14a Housing upper face
15 Linkage
16 Spring receiver
17 Damper
17a Piston
18 Spring receiver
18a Pin
21 Solenoid actuator
21a Plunger
22 Solenoid actuator
22b Plunger
53 Release linkage
53a Elongated hole
54 Release lever
54b Roller pin
62 Semi-cylindrical member
62a Protrusion
62b Return spring
70 Sub shaft
71 Sub lever
71a Pin
72 Latch lever
72a Roller
73 Cam lever
73a Roller
80 Linkage
82 Loading lever
82a Pin
82b Pawl
83 Linkage
84 Cam
90 Stopper lever
90a Stopper pin
90b Pin
90c Stopper pin
91 Latch
91a Rotation shaft
91b Pin
91c Return spring
91d Lever
91e Stopper lever
91f Solenoid actuator
92 Counterweight lever
93 Counterweight
94 Return spring
95 Vibration absorbing member
97 Pin
98 Ring
100 Rotation shaft
101 Center shaft
102 Plane
103 Roller receiver
301 Equivalent mass model of latch
302 Equivalent mass model of counterweight lever
303 Latch lever

1. An operating mechanism for a switchgear, the operating mechanism causing a movable contact to contact an opposing contact or to separate therefrom to change a condition between a current shutoff condition and a loading condition, the operating mechanism comprising:
a shutoff spring that is released when the condition transitions from the loading condition to the shutoff condition;
a main lever that is supported pivotally has one end linked with the shutoff spring and has an other end linked with the movable contact, and rotates upon receiving spring force by the shutoff spring to move the movable contact apart from the opposing contact;
a sub lever that has one end linked with the main lever, and is rotatable around an other end;
a sub shaft that fixes the other end of the sub lever, and is rotatable around the shaft of the sub shaft;
a latch lever that has one end fixed to the sub shaft, has an other end attached with a roller, and is rotatable around the one end together with an axial rotation of the sub shaft;
a latch that is supported pivotally has an end present on a movement trajectory of the roller when in the loading condition to suppress a rotation of the latch lever;
a weight lever that is provided with, at one end thereof, a weight which is separable from the end of the latch;
a return spring that is attached to an other end of the weight lever, and pushes the weight against the end so as to position the end of the latch on the movement trajectory of the roller; and
an actuator that pushes the weight to allow the latch to rotate, and to retract the latch from the movement trajectory of the roller.

2. The operating mechanism according to claim 1, wherein:
the latch comprises:
a plane that is provided at the end of the latch present on the movement trajectory of the roller, and abuts the roller; and
a rotation shaft provided on a virtual line orthogonal to the plane, and
the latch converts travelling force of the roller into force directed toward the rotation shaft through the plane when in the loading condition to further suppress a rotation of the latch lever.

3. The operating mechanism according to claim 1, further comprising:
a release linkage mechanism that is linked with the latch, and is movable upon receiving drive force by the actuator so as to release the latch from the movement trajectory of the roller; and
a return spring that pushes the end of the latch toward the movement trajectory of the roller,
wherein the actuator moves the linkage mechanism against the return spring.

4. The operating mechanism according to claim 3, wherein:
the release linkage mechanism comprises:
a pin disposed at the latch;
a linkage that has one end supported by the pin, and has an other end formed with an elongated hole; and
a lever that has one end provided with a pin which is slidable within the elongated hole, and
the actuator is a solenoid actuator that comprises a plunger which abuts an other end of the lever, and
when the plunger pushes the other end of the lever, a tip of the lever is pulled down, the linkage is pulled by the tip of the lever, the latch pushes the weight and rotates, and is retracted from the movement trajectory of the roller.

5. The operating mechanism according to claim 1, wherein:
an equivalent mass m1 of the latch and an equivalent mass m2 of the weight lever satisfy:
m2≧{e1/(1+e2+e1×e2)}×m1
where e1 is a rebound coefficient between the latch lever and the latch, and e2 is a rebound coefficient between the latch and the weight lever.

6. The operating mechanism according to claim 1, wherein a plurality of the weight levers each with the weight and a plurality of the return springs each for the weight are provided.

7. The operating mechanism according to claim 6, wherein the plurality of weights have different weights.

8. The operating mechanism according to claim 6, wherein the return springs of the weights have different elastic coefficients.

9. The operating mechanism according to claim 1, further comprising a return spring that returns the end of the latch to the movement trajectory of the roller.

10. The operating mechanism according to claim 1, further comprising:
a pin body disposed on the weight; and
a ring that has a larger internal diameter than an outer diameter of the pin body, has a substantially same outer diameter as an outer diameter of the weight, and is fitted to the pin body with a play.

11. The operating mechanism according to claim 1, further comprising a vibration absorbing member provided at the end of the latch.

12. The operating mechanism according to claim 1, further comprising:
a cam lever fixed to the sub shaft;
a loading shaft disposed in parallel with the sub shaft;
a loading cam fixed to the loading shaft, and having a cam face abutting the cam lever;
a loading lever that has one end fixed to the loading shaft, and rotates the loading shaft around the shaft thereof; and
a loading spring that is attached to an other end of the loading lever through a linkage mechanism, and pushes the loading lever so as to allow the loading lever to rotate when the condition transitions to the loading condition.

13. The operating mechanism according to claim 12, further comprising:
a pawl disposed at a tip of the loading lever;
a semi-cylindrical member to be engaged with the pawl;
a spring that pushes the semi-cylindrical member in a direction to be engaged with the pawl; and
an actuator that moves the semi-cylindrical member in a direction becoming apart from the pawl against pushing force by the spring.

14. A switchgear that changes a condition between a current shutoff condition and a loading condition, the switchgear comprising:
an opposing contact and a movable contact that are capable of contacting or separating relative to each other;
a shutoff spring that is released when the condition transitions from the loading condition to the shutoff condition;
a main lever that is supported pivotally has one end linked with the shutoff spring, has an other end linked with the movable contact, and rotates upon releasing of the shutoff spring to move the movable contact apart from the opposing contact;
a sub lever that has one end linked with the main lever, and is rotatable around an other end;
a sub shaft that fixes the other end of the sub lever, and is rotatable around the shaft of the sub shaft;
a latch lever that has one end fixed to the sub shaft, has an other end attached with a roller, and is rotatable around the one end together with an axial rotation of the sub shaft;
a latch that is supported pivotally has an end present on a movement trajectory of the roller when in the loading condition to suppress a rotation of the latch lever;
a weight lever that is provided with, at one end thereof, a weight which is separable from the end of the latch;
a return spring that is attached to an other end of the weight lever, and pushes the weight against the end so as to position the end of the latch on the movement trajectory of the roller; and
an actuator that pushes the weight to allow the latch to rotate, and to retract the latch from the movement trajectory of the roller.

15. The switchgear according to claim 14, wherein:
the latch comprises:
a plane that is provided at the end of the latch present on the movement trajectory of the roller, and abuts the roller; and
a rotation shaft provided on a virtual line orthogonal to the plane, and
the latch converts travelling force of the roller into force directed toward the rotation shaft through the plane when in the loading condition to further suppress a rotation of the latch lever.

16. The switchgear according to claim 14, wherein:
an equivalent mass m1 of the latch and an equivalent mass m2 of the weight lever satisfy:
m2≧{e1/(1+e2+e1×e2)}×m1
where e1 is a rebound coefficient between the latch lever and the latch, and e2 is a rebound coefficient between the latch and the weight lever.
